(19) United States
(12) Patent Application Publication
(10) Pub. No.: US 2008/0031245 A1
(43) Pub. Date: Feb. 7, 2008

(54) Uplink signaling for multicast transmission

(75) Inventor: Johanna Pekonen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/499,652

(22) Filed: Aug. 7, 2006

(30) Foreign Application Priority Data
Mar. 6, 2006 (EP) 06 004 510.1

(51) Int. Cl. H04L 12/56

(52) U.S. Cl. 370/390; 370/312

(57) ABSTRACT

The present invention relates to a method, system, terminal device and network element for signaling uplink control data for a multicast transmission of a cellular network, wherein an identification of a serving multicast cell is added to an uplink message which is transmitted in a transparent manner over a serving unicast cell to the cellular network. Based on this added identification, the uplink message can be forwarded to a serving network element of the serving multicast cell. Thereby, uplink messages, such as counting responses, can be supported, even if a terminal devices has a separate multicast receiver in addition to the unicast transceiver.

### FIELD OF THE INVENTION

The present invention relates to a method, system, terminal device and network element for signaling uplink control data for a multicast transmission of a cellular network. In particular, the present invention relates to—but is not restricted to—uplink signaling in a Multimedia Broadcast and Multicast Service (MBMS).

### BACKGROUND OF THE INVENTION

The Universal Mobile Telecommunications System (UMTS) specified by the third generation partnership project (3GPP) shall offer appealing multimedia services. When many users want to receive the same multimedia services at the same time, like news services, even high bandwidth UMTS radio resources might run into shortage. Efficiency of resource allocation can be improved when many radio channels transfer data in parallel to different users within the same radio cell. A resource and therefore cost efficient delivery of multimedia services to a large number of users in parallel is given by broadcast or multicast services. As an example, 3GPP defined MBMS as a service which shares network resources, specifically radio resources, when transferring data to many users in parallel. MBMS is an Internet Protocol (IP) datacast type of service that can be offered via existing cellular networks, such as Global System for Mobile Communications (GSM) or UMTS networks. The infrastructure gives the possibility to use an uplink channel for interactions between the service and the user. This is however not a straight forward issue in usual broadcast networks, as for example conventional digital television is only a one-way or point-to-point (unicast) system.

In general, a broadcast service can be generalized to mean a unidirectional point-to-multipoint service in which data is transmitted from a single source to multiple terminals, e.g. user equipment (UE) in third generation terminology, in the associated broadcast service area. In other words, broadcast services can be called push-type services. On the other hand, a multicast service can be defined as a unidirectional point-to-multipoint service in which data is transmitted from a single source to a multicast group in the associated multicast service area. Only the users that are subscribed to the specific multicast service and have joined the multicast group associated with the service can receive the multicast services. As a difference, a broadcast service can be received without separate indication from the customers.

In addition to joining a Multicast service (becoming a member of a Multicast group, 3GPP TS 23.246) the network may use the procedures called counting at the start of a MBMS session and re-counting during the MBMS session to find out whether there are any interested users (=joined users) in the cells belonging to the associated MBMS service area. This counting procedure can be executed several ways. Typically, the network indicates at the start of the MBMS session during the MBMS Notification procedure, that counting is initiated and the interested terminals (or certain amount of the interested terminals) will respond to the counting request by using uplink signaling resources. The counting (or re-counting) procedure can be used e.g. to check whether there is at least one interested user in each cell or to check, whether there is a certain amount of the users in a cell or then just to count the total number of the users per cell. This counting information can be used to optimize the data transmission: e.g. the radio resources are not allocated to a particular MBMS service in a cell, in which there are no interested users to receive data for that particular MBMS service. In practice, multicast users need a return channel for the interaction procedures in order to be able to respond to the counting requests, which are received at the session start as part of the MBMS notification or then during the MBMS session as a separate procedure.

MBMS thus can be defined as a unidirectional point-to-multipoint service in which data is transmitted from a single source entity to a group of users in a specific area. As its name indicates, MBMS has two modes in practice: broadcast mode and multicast mode.

In 3GPP a working assumption for the downlink multiple access technology has been taken and it has been agreed to use Orthogonal Frequency Division Multiple Access (OFDMA) based technology in the downlink. OFDM is also being used for systems like Digital Video Broadcast (DVB) and DVB-Handheld (DVB-H).

The use of OFDM is well suited in DVB for receiving the same synchronized content from different synchronized transmitters to enable coherent combination of the content.

The Multimedia Broadcast/Multicast Services have the possibility to optimize the allocated resources for the data transmission by using Point-to-Multipoint transmission in case there is more than one user interested to get certain data flow in the same cell.

In 3GPP Release 6 MBMS solution, it is assumed that the MBMS data and the user specific point-to-point connections are transmitted or routed through the same cell and the terminal device uses the same receiver for unicast and MBMS reception. There have been initial proposals to provide a separate receiver for MBMS reception in terminal devices, which allows provision of MBMS-specific cells. The separate MBMS receiver in the terminals is an approach similar to DVB-H, where a separate DVB-H receiver is included in a cellular mobile device.

However, the Release 6 MBMS solution contains several procedures which require uplink signalling from the terminal device towards the network. One of these procedures is e.g. response to a counting request at the session start or during re-counting. With a response message to the counting request, the terminal device indicates that it is interested to receive the starting MBMS session through a particular MBMS cell which is sending the counting request. This uplink signalling for responding to a counting request can be necessary, if optimization in resource allocation for data transmission is required.

The Release 6 based solution in MBMS is, that the terminal device responds through the MBMS cell, which is requesting for the counting. But, as the approach of having more than one transmitter on in the terminal device at the same time is not possible due to the complexity in the terminal implementation, the terminal device cannot respond to the counting request received from the serving MBMS cell.

### SUMMARY OF THE INVENTION

It is therefore an object of the present invention to provide an alternative uplink signaling scheme, by means of which multicast uplink control signaling can be provided by terminal devices with separate multicast receivers.

This object is achieved by a method of signaling uplink control data for a multicast transmission of a cellular network, said method comprising the steps of:
adding an identification of a serving multicast cell to an uplink message;
transmitting said uplink message in a transparent manner over a serving unicast cell to said cellular network; and
forwarding said uplink message to a serving network element of said serving multicast cell based on said added identification.

Furthermore, the above object is achieved by a system for signaling uplink control data for a multicast transmission of a cellular network, said method comprising the steps of:
adding means adding an identification of a serving multicast cell to an uplink message;
transmitting means for transmitting said uplink message in a transparent manner over a serving unicast cell to said cellular network; and
forwarding means for forwarding said uplink message to a serving network element of said serving multicast cell based on said added identification.

Additionally, the above object is achieved by a terminal device for signaling uplink control data for a multicast transmission of a cellular network, said terminal device being configured to add an identification of a serving multicast cell to an uplink message, and to transmit said uplink message in a transparent manner over a serving unicast cell to said cellular network.

Finally, the above object is achieved by a network element for serving a unicast cell of a cellular network, said network element being configured to detect a cell identification of a received transparent uplink message and to forward said transparent uplink message to a serving network element of a multicast cell based on said detected cell identification.

Accordingly, the terminal device can use the serving unicast cell for any multicast-related uplink signalling. For any uplink response or other uplink signaling the terminal device sends a message transparently over the serving unicast cell to the serving multicast cell or to the network entity controlling the radio resource allocation of the serving multicast cell (e.g. to RNC in UTRAN). Uplink signaling can thus be supported, even if the terminal device has a separate multicast receiver in addition to the unicast transceiver.

In a first implementation example, the uplink message may be forwarded via a direct connection from a serving network element of the serving unicast cell to the serving network element the of the serving multicast cell.

In a second implementation example, the uplink message may be forwarded from the serving network element of the serving unicast cell via an access gateway element or serving support node to the serving network element of the serving multicast cell.

As a specific example, the uplink message may transmitted in response to a multicast notification received via a common control channel. More specifically, this multicast notification may contain a counting request and the uplink message may be a counting response. Then, the multicast notification may comprise the identification which may comprise, for example, a cell ID of the serving multicast cell or an IP address of the serving network element of the serving multicast cell.

Further advantageous modifications are defined in the dependent claims.

### BRIEF DESCRIPTION OF THE DRAWINGS

In the following, the present invention will be described in greater detail based on a preferred embodiment with reference to the accompanying drawings, in which:

FIG. 1A and FIG. 1B show alternative schematic block diagrams of an MBMS architecture in which the present invention can be implemented; and

FIG. 2 shows a schematic signaling diagram for delivery of multicast related uplink signaling according to the preferred embodiment.

### DESCRIPTION OF THE PREFERRED EMBODIMENT

The preferred embodiment will now be described based on an MBMS service in a UTRAN Release-6 and a UTRAN LTE (UMTS Terrestrial Radio Access Network Long Term Evolution) or 3.9G environment.

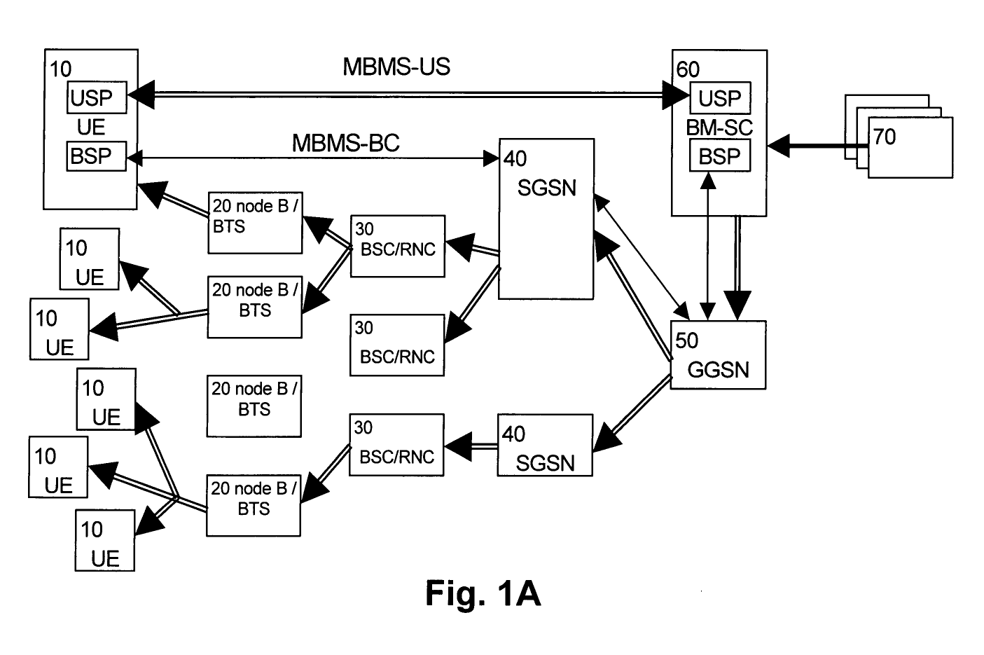

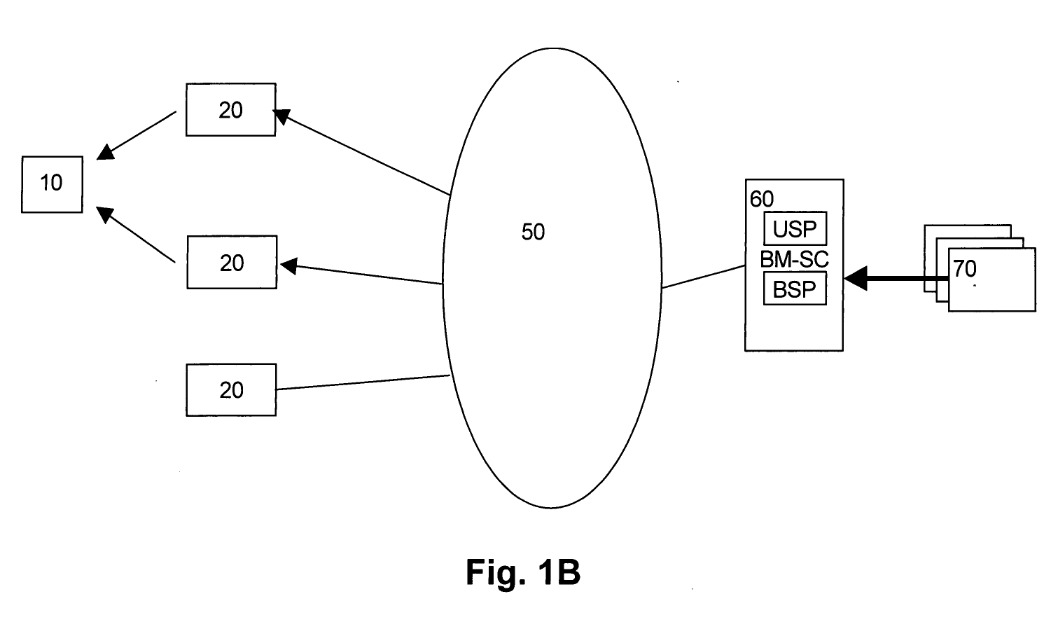

FIG. 1A shows a schematic block diagram of a general MBMS architecture in relation to the UTRAN Release-6 MBMS architecture, in which the invention can be implemented.

FIG. 1B shows a schematic block diagram of an alternative MBMS architecture in relation to the UTRAN LTE or 3.9G.

According to FIGS. 1A and 1B, content sources 70, such as Internet servers or the like, supply MBMS content to a broadcast multicast service center (BM-SC) 60. The BM-SC 60 provides MBMS user service, i.e., delivering service data and performing related control actions. Thus, the BM-SC 60 comprises functions for MBMS user service provisioning and delivery. It may serve as an entry point for content provider MBMS transmissions, used to authorize and initiate MBMS bearer services within the cellular network, and can be used to a schedule and deliver MBMS transmissions. Among other functions, the BM-SC 60 is able to schedule MBMS session retransmissions, and label each MBMS session with an MBMS session identifier to allow user equipments (UEs) 10 to distinguish MBMS session retransmissions. These retransmissions are transparent to the radio access network and MBMS user service (MBMS-US).

The MBMS-US covers applications for delivering content data to many users, e.g. news services, audio or video clips, etc. It is to a large extent independent from the user transport services, as long as IP multicast is compatible. Moreover, MBMS-US provides means for user authorization, charging and quality of service (QoS) improvement and prevents unauthorized reception by encryption or digital rights management (DRM). On the other hand, the MBMS-BC provides an IP multicast like transport service for MBMS user services. It maintains a one to many data distribution tree into all necessary radio cells and may provide transport related charging.

In the example shown in FIGS. 1A and 1B, the MBMS content is not delivered to one of the base station devices 20, which may be outside the area specified for the actually transmitted MBMS content.

In the specific architecture of FIG. 1A, the UEs 10 support functions for activating/deactivating the MBMS bearer service based on a MBMS bearer control signaling (MBMS-BC). Once a particular MBMS bearer service is activated no further explicit user request is required to receive MBMS data, although the user may be notified that data transfer is about to start. The UEs 10 may support security functions as appropriate for MBMS. Depending on terminal capabilities, the UEs 10 may be able to receive MBMS user service announcements, paging information or support simultaneous services. Based on the MBMS session identifier contained in the notification, the UEs 10 are able to decide whether they need to ignore the forthcoming transmission of MBMS session, e.g., because the respective UE has already received this MBMS session.

Each UE 10 comprises a user service part (USP) for handling application signaling of MBMS-US and a bearer service part (BSP) for handling MBMS-BC signaling. Similarly, the BM-SC 60 comprises a USP for application signaling and a BSP for bearer control signaling. This bearer control signaling is routed via the packet switched domain of the core network and the radio access network to the BSP of the UEs 10. It is noted that in FIG. 1A, every UE 10 comprises the USP and BSP, which have been omitted in the other UEs 10 for reasons of simplicity.

The bearer control signaling is routed via a General Packet Radio Services (GPRS) support node (GGSN) 50 and a Serving GPRS support node (SGSN) 40 to the UEs 10. Based on this MBMS bearer control signaling, a one to many data distribution tree indicated by the bigger arrows is maintained so as to provide the MBMS content to specific areas or cells of the cellular network. The radio access network (RAN) part comprises base station devices 20, e.g. a node B or base transceiver station (BTS), for providing an air interface for radio transmission to respective UEs 10 within their areas of coverage. The base station devices 20 are connected to network controller devices 30, e.g. a base station controller (BSC) or a radio network controller (RNC) for switching purposes, which are connected to the SGSNs 40.

In the alternative architecture of FIG. 1B, the data stream with the MBMS content is delivered via an access gateway 130, such as an Enhanced UTRAN (E-UTRAN) Access Gateway (aGW) and a radio access network (RAN) part to the respective ones of the UEs 10. The aGW 130 in the E-UTRA architecture has similarities with the SGSN 40 in UTRAN Release-6 architecture of FIG. 1A, which SGSN does not exist in the E-UTRA architecture. The RAN part comprises base station devices 20, e.g. a node B or base transceiver station (BTS), for providing an air interface for radio transmission to respective UEs 10 within their areas of coverage.

According to the preferred embodiment, the UEs 10, at least some of which may have a separate MBMS receiver, will use their serving unicast cell for any MBMS uplink signalling. Throughout the following, a “serving unicast cell” means any cell which a concerned terminal device (e.g. UE 10) may use for unicast services.

In the example of the initial counting procedure, the UE 10 will send a counting response message transparently over the respective serving unicast cell to the respective serving MBMS cell. To achieve this, the UE 10 adds an identification of the MBMS cell (e.g. Cell ID or an IP address of the multicast serving network element (e.g. MBMS E-UTRAN Node B (MeNB)) to the response message, so that the response message contains this identification. Based on the identification of the MBMS cell, the unicast cell is able to forward the transparent message to the correct multicast serving element (e.g. MeNB). According to a first implementation example (e.g. using similar interface to lur interface in UTRAN), this forwarding may be achieved via a direct connection between the unicast serving network element (e.g. E-UTRAN Node B (eNB)) and the multicast-serving network element (e.g. MeNB). As an alternative, in a first aspect of a second implementation example (e.g. in LTE) forwarding may be achieved via a gateway element (e.g. aGW) to the serving network element of the serving multicast cell. As another alternative, in a second aspect of the second implementation example (e.g. in UTRAN or GERAN (GSM/EDGE Radio Access Network) forwarding may be achieved via the SGSN 40 to the serving network element of the serving multicast cell.

Initially, the serving MBMS cell sends an MBMS notification (e.g. counting request) on a common control channel. A part of this MBMS notification message is a request to respond to the MBMS notification. In case of the exemplary counting request, those UEs 10 which are interested in receiving or have joined the notified MBMS session may respond to this counting request by sending a counting response message via it's serving unicast cell. The identifier defining the target MBMS serving network element (e.g. MeNB) or target MBMS cell can be included in the MBMS notification (e.g. counting request) broadcasted by the MBMS cell and it can be e.g. the Cell ID of the target MBMS cell or the IP address of the MBMS serving network element of the target MBMS cell.

Based on the identifier or identification added to the response message the unicast cell will forward the response message directly to the serving network element (e.g. MeNB) of the respective MBMS cell, if there is a connection interface between the unicast serving network element (e.g. eNB) and MBMS serving network element (e.g. MeNB), or alternatively via the gateway element(s) (e.g. aGW(s)) or SGSN(s) 40, depending on the network environment.

The content of the response message is transparent for the serving unicast cell and for the gateway element (e.g. aGW) or SGSN 40 (if involved in the delivery path).

It is noted that the present invention is not restricted to the counting mechanism. The solution may as well be used in connection with other solutions, such as a case where the UE 10 enters a new MBMS cell after MBMS cell reselection, if the new MBMS cell belongs to the service area of the ongoing session, but the data transmission through the new MBMS cell is not on. The UE 10 can then indicate it's existence to the new MBMS cell by using the proposed uplink signalling via the serving unicast cell. Additionally, using the common control channels is only one possible solution for delivery of the identifier defining the target MBMS serving network element (e.g. MeNB) or target MBMS. Of course, other signaling solutions based on alternative channels or methods might be used as well.

Without the proposed uplink signalling, counting or other uplink signalling cannot be supported, if the terminal has a separate MBMS receiver in addition to the unicast transceiver.

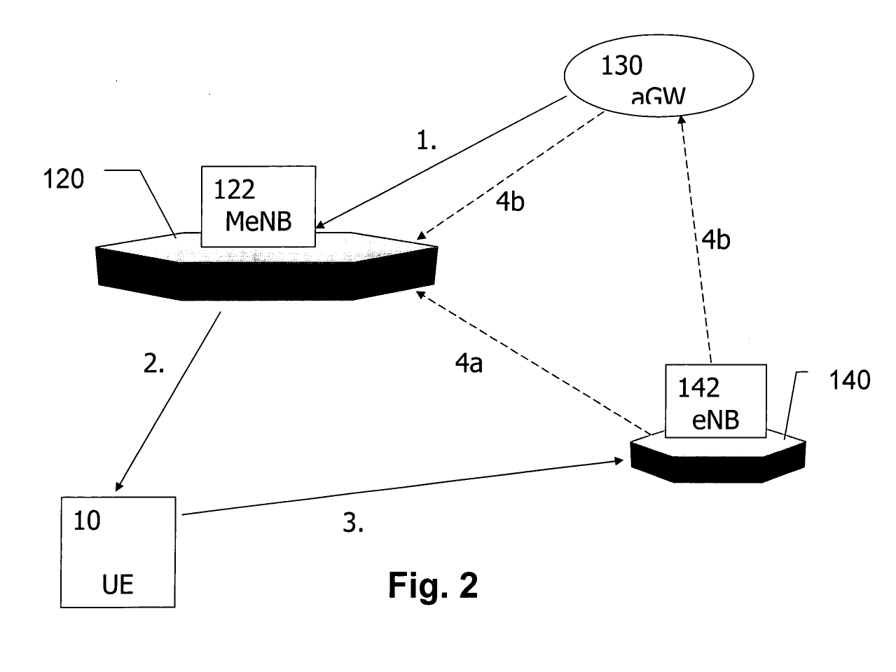

FIG. 2 shows a schematic diagram indicating signaling steps for delivery of the MBMS related uplink signaling in the architecture of FIG. 1B via the serving unicast cell during a MBMS notification in an MeNB approach with counting (e.g. MBMS Multicast).

In step 1, the aGW 130 sends an MBMS session start request to an MeNB 122 of a serving MBMS cell 120 of a UE 10. In response thereto, the MeNB 122 transmits in step 2 an MBMS notification including a counting request on a common control channel in the MBMS cell 120. Then, in step 3, a response message to the counting is transmitted from the UE 10 to a serving unicast cell 140, wherein the UE 10 would be in LTE RRC (Radio Resource Control) active state to transmit the response message. The target MeNB 122 is identified in the response message, e.g., with the Cell ID of the MBMS cell 120.

According to a first option, a transparent transmission of the response message to the MeNB 122 or to the RRM (Radio Resource Management) entity controlling the MBMS radio resources is performed by the respective eNB 142 in step 4a.

According to a second option, a transparent transmission of the response message is performed in step 4b from the eNB 142 via the aGW 130 to the MeNB 122 or to the entity controlling the radio resources of the MBMS cell 140.

Thus, for systems in which MBMS data transmission is initiated through pure MBMS cells possibly requiring separate MBMS receiver in the terminal device, uplink control signaling related to the MBMS transmission (e.g. counting response) can be initiated through a second cell, which is used for unicast traffic by the terminal.

In summary, a method, system, network element and terminal device have been described, which are used for signaling uplink control data for a multicast transmission of a cellular network, wherein an identification of a serving multicast cell is added to an uplink message which is transmitted in a transparent manner over a serving unicast cell to the cellular network. Based on this added identification, the uplink message can be forwarded to a serving network element of the serving multicast cell. Thereby, uplink messages, such as counting responses, can be supported, even if a terminal devices has a separate multicast receiver in addition to the unicast transceiver.

The present invention is not restricted to the above predetermined embodiment with its specific network elements. For example, the present invention is applicable to the UTRAN MBMS, which is using Release 6 network architecture and MBMS procedures and to the MBMS using Evolved UTRA (i.e., UTRAN LTE (UMTS Terrestrial Radio Access Network Long Term Evolution) (E-UTRA, 3GPP TR 25.813: Evolved Universal Terrestrial Radio Access Network (E-UTRAN); Radio interface protocol aspects). Moreover, the present invention is not restricted to the MBMS service, but can be used for any multicast or broadcast service an uplink control signaling is required. The preferred embodiments may thus vary within the scope of the attached claims.

1. A method of signaling uplink control data for a multicast transmission of a cellular network, said method comprising the steps of:
a) adding an identification of a serving multicast cell to an uplink message;
b) transmitting said uplink message in a transparent manner over a serving unicast cell to said cellular network; and
c) forwarding said uplink message to a serving network element of said serving multicast cell based on said added identification.

2. A method according to claim 1, wherein said uplink message is forwarded via a direct connection from a serving network element of said serving unicast cell to said serving network element of said serving multicast cell.

3. A method according to claim 1, wherein said uplink message is forwarded from a serving network element of said serving unicast cell via a gateway element or serving support node to said serving network element of said serving multicast cell.

4. A method according to claim 1, wherein said uplink message is transmitted in response to a multicast notification.

5. A method according to claim 4, wherein said multicast notification contains a counting request and said uplink message is a counting response.

6. A method according to claim 4, wherein said multicast notification comprises said identification.

7. A method according to claim 1, wherein said identification comprises a cell ID of said serving multicast cell or an IP address of said serving network element of said serving multicast cell.

8. A system for signaling uplink control data for a multicast transmission of a cellular network, said method comprising the steps of:
a) adding means for adding an identification of a serving multicast cell to an uplink message;
b) transmitting means for transmitting said uplink message in a transparent manner over a serving unicast cell to said cellular network; and
c) forwarding means for forwarding said uplink message to a serving network element of said serving multicast cell based on said added identification.

9. A system according to claim 8, wherein said forwarding means are configured to forward said uplink message via a direct connection to said serving network element of said serving multicast cell.

10. A system according to claim 8, wherein said forwarding means are configured to forward said uplink message via a gateway element or serving support node to said serving network element of said serving multicast cell.

11. A system according to claim 8, wherein said transmitting means are configured to transmit said uplink message in response to a multicast notification received from said serving network element of said serving multicast cell.

12. A system according to claim 11, wherein said multicast notification contains a counting request and said uplink message is a counting response.

13. A system according to claim 11, wherein said multicast notification comprises said identification.

14. A system according to claim 8, wherein said identification comprises a cell ID of said serving multicast cell or an IP address of said serving network element of said serving multicast cell.

15. A terminal device for signaling uplink control data for a multicast transmission of a cellular network, said terminal device being configured to add an identification of a serving multicast cell to an uplink message, and to transmit said uplink message in a transparent manner over a serving unicast cell to said cellular network.

16. A terminal device according to claim 15, wherein said terminal device is configured to transmit said uplink message in response to a received multicast notification.

17. A terminal device according to claim 16, wherein said terminal device is configured to derive said identification from said received multicast notification.

18. A terminal device according to claim 16, wherein said multicast notification contains a counting request and said uplink message is a counting response.

19. A network element for serving a unicast cell of a cellular network, said network element being configured to detect a cell identification of a received transparent uplink message and to forward said transparent uplink message to a serving network element of a multicast cell based on said detected cell identification.

20. A network element according to claim 19, wherein said network element is configured to forward said uplink message via a gateway element or serving support node to said serving network element of said serving multicast cell.

21. A system for signaling uplink control data for a multicast transmission of a cellular network, said system comprising:
a) an adding unit configured to add an identification of a serving multicast cell to an uplink message;
b) a transmitting unit configured to transmit said uplink message in a transparent manner over a serving unicast cell to said cellular network; and
c) a forwarding unit configured to forward said uplink message to a serving network element of said serving multicast cell based on said added identification.
